(19) United States
(12) Patent Application Publication
(10) Pub. No.: US 2020/0156449 A1
(43) Pub. Date: May 21, 2020

(54) ADHESIVE SUNSHADE WITH REFLECTIVE INDICIA AND METHOD OF USING

(71) Applicant: Mustfa Raad, Reston, VA (US)

(72) Inventor: Mustfa Raad, Reston, VA (US)

(21) Appl. No.: 16/685,407

(22) Filed: Nov. 15, 2019

Related U.S. Application Data
(60) Provisional application No. 62/767,744, filed on Nov. 15, 2018.

(51) Int. Cl. B60J 3/02; B32B 25/20; B32B 27/36; B32B 25/08; B32B 7/12; B32B 27/32

(52) U.S. Cl. CPC B60J 3/0286; B32B 25/20; B32B 27/36; B32B 2307/71; B32B 7/12; B32B 27/32; B32B 2307/414; B32B 25/08

(57) ABSTRACT

A self-adhering sunshade including a self-adhering layer detachably coupleable to a window, and a protective layer coupled to the self-adhering layer and configured to block sunlight, ultraviolet light and heat from passing through.

### BACKGROUND OF THE INVENTION

### 1. Field of Invention

The present inventive concept relates to sunshades, and more particularly to self-adhering sunshades having reflective text and graphics.

### 2. Description of the Related Art

There are millions of drivers and passengers that drive vehicles on roads every day. However since windows and windshields on vehicles are designed to provide complete visibility of the road, they do not adequately protect the drivers and passengers from harmful rays from the sun.

Although there have previously been many types of sunshades and visors developed to shield occupants from the sun, these conventional sun visors fail to adequately protect occupants from sun rays and ultraviolet radiation. As a result, the occupants of these vehicles, especially elderly occupants, become extremely hot and risk having heat strokes

Further, many of the conventional sunshades are bulky and inconvenient to use and are often aesthetically unpleasant to the users.

Thus, what is desired is a convenient, easy to use and aesthetically pleasing sunshade integrated with customizable indicia designed to protect occupants of vehicles or homes from harmful rays from the sun.

### SUMMARY OF THE INVENTION

An aspect and/or utility of the present general inventive concept is to provide a novel method of providing shade for vehicular occupants. The flexible, sticky, non-transparent, transparent, and/or planar shape of the item allows it to be configured to fit a variety of compound-curved window types within an automobile or home.

Another aspect and/or utility of the present general inventive concept is also to provide a method to provide shade and affix the invention to a multitude of sash-oriented windows such as those found on homes and offices.

Another aspect and/or utility of the present general inventive concept is also to provide customized indicia that can reflect light allowing said letters to be visible at a distance.

Another aspect and/or utility of the present general inventive concept is also to provide customized graphics that also can be reflected and seen from a distance.

The present invention comprises a method for affixing a sunscreen to a window by means of an adhesive layer therein. The adhesion allowing the screen to be removably affixed to a substrate for an extremely long period of time.

An adhesive sunshade with reflective indicia and graphics is disclosed. The invention being comprised of a planar, plastic sheet having an adhesive portion on one side and a sunscreen coating on another side. Said sunscreen portion having indicia and graphics allowing the sun to reflect therefrom. An object of the invention is to allow users to be protected from the sun while in a vehicle or inside a home and display customized messages, graphics, or artwork. The sunshade can take various shapes and sizes.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

An exemplary embodiment of the present general inventive concept, which in no way limits the claims will now be more particularly described by way of example with reference to the accompanying drawings.

### BRIEF DESCRIPTION OF THE DRAWINGS

The above-mentioned features of the invention will become more clearly understood from the following detailed description of the invention read together with the drawings in which:

FIG. 1 illustrates a front perspective view of a self-adhering sunshade according to an example embodiment of the present general inventive concept;

FIG. 2 illustrates an enlarged detail view of detail A illustrated in FIG. 1;

FIG. 3 illustrates an enlarged detail cross section view of a self-adhering sunshade according to another embodiment of the present general inventive concept;

FIG. 4 illustrates front view of the self-adhering sunshade illustrated in FIG. 1;

FIG. 5 illustrates a perspective view of the self-adhering sunshade illustrated in FIG. 1 removably coupled to a vehicle; and

FIG. 6 illustrates a perspective view of the self-adhering sunshade illustrated in FIG. 1 removably coupled to a building.

### DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The general inventive concept is further described in the detailed description that follows, by reference to the noted drawings by way of non-limiting illustrative exemplary embodiments of the general inventive concept, in which like reference numerals represent similar parts throughout the drawings. As should be understood, however, the general inventive concept is not limited to the precise arrangements and instrumentalities illustrated.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The present general inventive concept provides users the ability to block sunlight, ultraviolet light, and heat from entering a vehicle or building through a window.

The present general inventive concept also provides users the ability to block sunlight, ultraviolet light, and heat from entering a vehicle or building through a window, while displaying an aesthetically pleasing image or logo.

The present general inventive concept also provides users the ability to block sunlight, ultraviolet light, and heat from entering a vehicle or building through a window using a self-adhering and removable sunshade. The self-adhering sunshade may be integrated with a reflective layer to illuminate the aesthetically pleasing image using sunlight. The self-adhering sunshade may be formed of a transparent self-adhering sticky material.

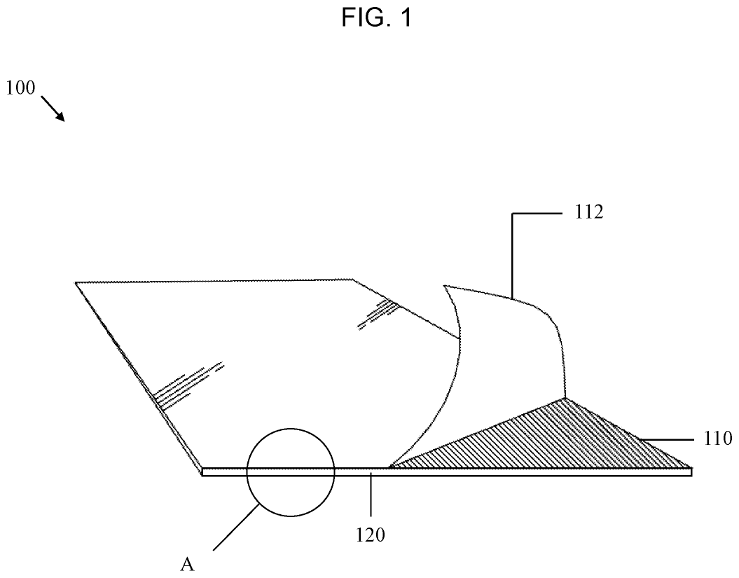

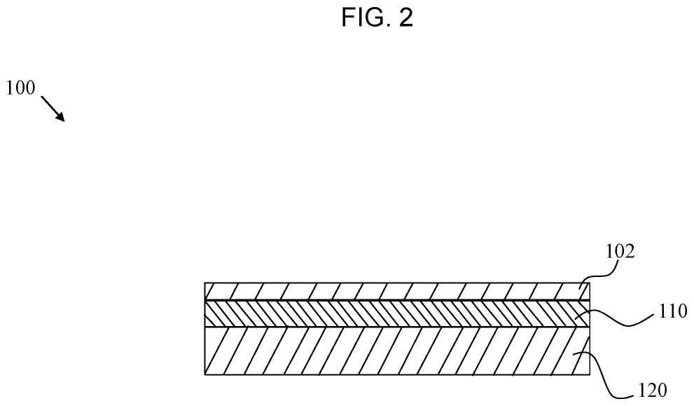

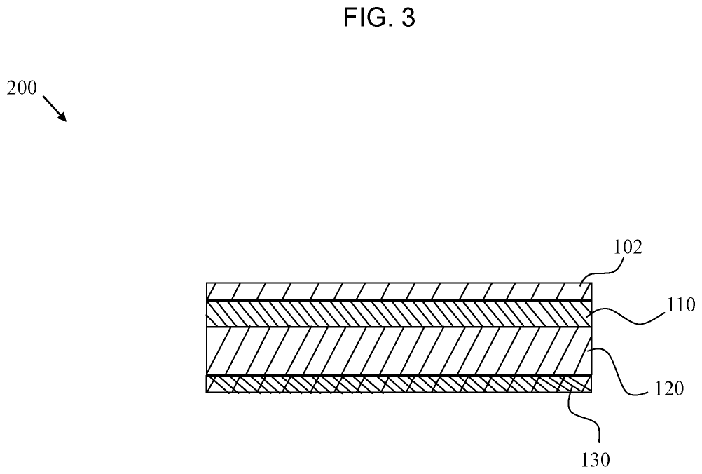

FIG. 1 illustrates a front perspective view of a self-adhering sunshade 100 according to an example embodiment of the present general inventive concept. FIG. 2 illustrates an enlarged detail view of detail A illustrated in FIG. 1. FIG. 3 illustrates front view of the self-adhering sunshade 100 illustrated in FIG. 1.

Referring to FIGS. 1 through 2, the self-adhering sunshade, designated generally as 100, is illustrated. In the present embodiment, the self-adhering sunshade 100 is designed and/or configured to block sunlight, ultraviolet light, and/or heat from entering a vehicle 10 or building 12 through a window. The self-adhering sunshade 100 includes a self-adhering layer 110 detachably coupleable to a window or windshield and a protective layer 120 coupled to the self-adhering layer 110 configured to block sunlight, ultraviolet light, and/or heat from passing through to protect occupants of vehicles or buildings.

The self-adhering sunshade may further include a removable film layer 112 disposed on the self-adhering layer 110 to protect from dust or debris during storage.

In the present embodiment, the self-adhering layer 110 and the protective layer 120 are formed in a substantially rectangular shape and have a height of approximately 1 to 50 inches and a width of approximately 1 to 50 inches. Further, the self-adhering layer 110 and the protective layer 120 may have a combined thickness of approximately 0.01 to 15 inches. However, the present general inventive concept is not limited thereto.

In the present embodiment, the self-adhering layer 110 and/or the protective layer 120 may be formed of a thin polyester laminate film, such as but not limited to plastic, polyethylene, and the like. However, the present general inventive concept is not limited thereto. That is, in alternative embodiments, the self-adhering layer 110 and the protective layer 120 may be formed of various materials in various shapes and sizes, as desired.

In alternative embodiments, the self-adhering sunshade 100 may have various height and width dimension, including but not limited to a height of about 13 inches and a width of about 13 inches, a height of about 11 inches and a width of about 25 inches, a height of about 17 inches and a width of about 22 inches, and a height of about 10 inches and a width of about 17 inches.

In the present embodiment, the self-adhering layer 110 may be formed of a sticky material designed to be removably attached or coupled to a window or windshield. However, the present invention is not limited thereto. That is, in alternative embodiments, the self-adhering layer 110 may include an adhesive material or layer configured to detachably couple to a window of a vehicle 10 or building 12.

In the present embodiment, the self-adhering layer 110 may have thickness of about 1 millimeter to about 50 millimeters. In an embodiment, the self-adhering layer 110 may have a thickness of about 1 millimeter to about 5 millimeters. However, the present invention is not limited thereto.

In the present embodiment, the protective layer 120 blocks ultraviolet light from reaching occupants within the vehicle 10 or building 20. The protective layer 120 may further include a sun block rating of, but not limited to Ultraviolet 400 blocking wavelengths up to 400 nanometers (UVA and UVB rays) and providing a means to protect users within the vehicle or building from harmful rays or window glare. In the present embodiment, the self-adhering layer 110 is manufactured from a material that blocks 100% of UVA and UVB rays.

In the present embodiment, the self-adhering layer 110 may be washable with warm water.

In alternative embodiments, the self-adhering layer 110 and/or the protective layer 120 may be formed of a translucent or non-translucent material. In yet further embodiments, the self-adhering layer 110 and/or the protective layer 120 may be formed of a silicone rubber material. However, the present general inventive concept is not limited thereto.

Referring to FIG. 3, in alternative embodiments, the self-adhering sunshade 100 includes a self-adhering layer 110 and a protective layer 120 coupled to the self-adhering layer 110. The self-adhering sunshade 100 further includes a removable film layer 112 disposed on the self-adhering layer 110 to protect against dust and debris. The self-adhering layer 110, the protective layer 120, and the removable film layer 112 are formed in a substantially rectangular shape having a width of about 2 inches and a length of about 6 inches. The self-adhering layer 110 is manufactured from a sticky material and the protective layer 120 is manufactured from a material designed to block heat and light.

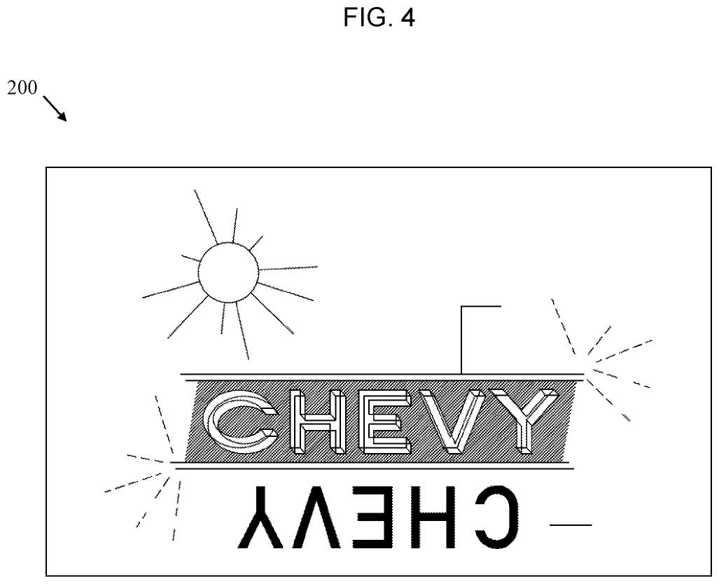

Referring to FIG. 4, in alternative embodiments, the self-adhering sunshade 200 further includes an indicia layer 130 designed to illuminate a custom design or logo when sunlight enters the protective layer 120, thereby displaying an illuminated image or logo.

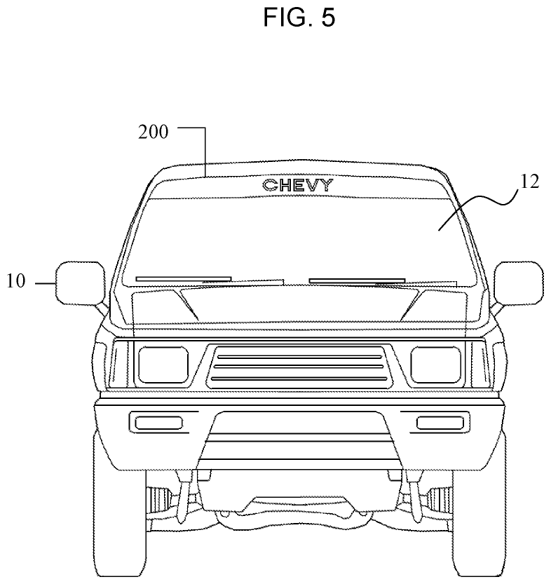

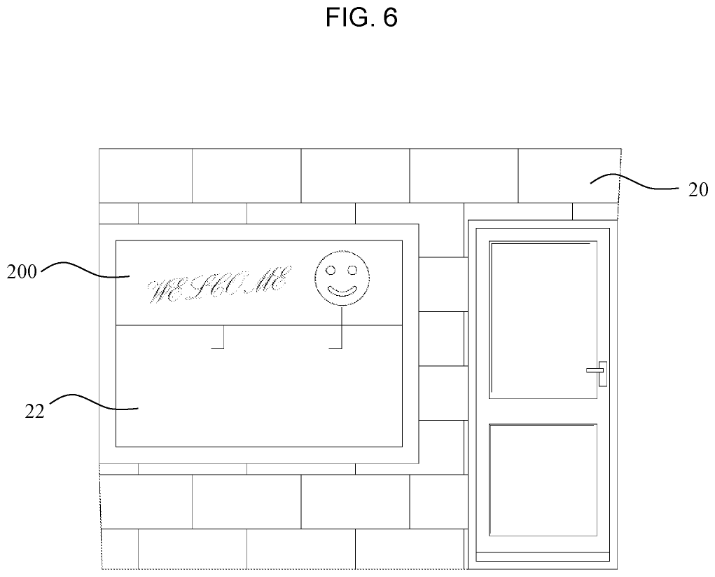

FIG. 5 illustrates a perspective view of the self-adhering sunshade illustrated in FIG. 1 removably coupled to a vehicle. FIG. 6 illustrates a perspective view of the self-adhering sunshade illustrated in FIG. 1 removably coupled to a building.

Referring to FIG. 5, the self-adhering sunshade 200 is placed on the interior windshield 12 of the vehicle 10. The indicia layer 130 is clearly visible from the outside, while simultaneously blocking occupants within the vehicle 10 from sunlight, heat, and ultraviolet radiation.

Similarly, referring to FIG. 6, the self-adhering sunshade 200 is placed on the interior window 22 of the building 20. The indicia layer 130 is clearly visible from the outside, while simultaneously blocking occupants within the building 20 from sunlight, heat, and ultraviolet radiation.

The present general inventive concept provides users the ability to block sunlight, ultraviolet light, and heat from entering a vehicle or building through a window using a self-adhering and removable sunshade. The self-adhering sunshade may be integrated with a reflective layer to illuminate the aesthetically pleasing image using sunlight. The self-adhering sunshade may be formed of a transparent self-adhering sticky material.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A self-adhering sunshade comprising:
a self-adhering layer detachably coupleable to a window; and
a protective layer coupled to the self-adhering layer and configured to block sunlight, ultraviolet light and heat from passing through.

2. The self-adhering sunshade of claim 1, wherein the self-adhering layer is formed of a sticky material.

4. The self-adhering sunshade of claim 2, wherein the protective layer blocks ultraviolet light from reaching the self-adhering layer.

5. The self-adhering sunshade of claim 2, wherein the self-adhering layer includes an adhesive material.

6. The self-adhering sunshade of claim 1, further comprising a removable film layer disposed on the self-adhering layer.

7. The self-adhering sunshade of claim 1, wherein the self-adhering layer is formed of a translucent material.

8. The self-adhering sunshade of claim 2, wherein the protective layer is formed of a translucent material.

9. The self-adhering sunshade of claim 1, wherein the self-adhering layer is formed of a non-translucent material.

10. The self-adhering sunshade of claim 9, wherein the protective layer is formed of a non-translucent material.

11. The self-adhering sunshade of claim 10, wherein the self-adhering layer and the second protective layer are formed in a substantially rectangular shape.

12. The self-adhering sunshade of claim 11, wherein the self-adhering layer and the second protective layer are approximately 6 inches in height and approximately 8 inches in width.

13. The self-adhering sunshade of claim 11, wherein the self-adhering layer and the second protective layer have a combined thickness of approximately 0.25 inches.

14. The self-adhering sunshade of claim 1, wherein the self-adhering layer and the second protective layer have a combined thickness of approximately 0.25 inches.

15. The self-adhering sunshade of claim 1, wherein the self-adhering layer is formed of a silicone rubber material.

16. A method of blocking sun from a vehicle using a self-adhering sunshade, the self-adhering sunshade comprising a self-adhering layer detachably coupleable to a window and a protective layer coupled to the self-adhering layer and configured to block sunlight, ultraviolet light and heat from passing through, the method comprising:
placing the self-adhering layer of the self-adhering sunshade against an interior surface of a window of the vehicle.
